(19) United States
(12) Patent Application Publication
(10) Pub. No.: US 2005/0266713 A1
(43) Pub. Date: Dec. 1, 2005

(54) Hermaphroditic in-line handle and receptacle assembly

(76) Inventors: James L. Bordeau, Sidney, NY (US); David O. Gallusser, Oneonta, NY (US)

Correspondence Address: BLANK ROME LLP, 600 NEW HAMPSHIRE AVENUE, N.W., WASHINGTON, DC, 20037, US

(21) Appl. No.: 10/854,184

(22) Filed: May 27, 2004

(51) Int. Cl. H01R 13/53

(52) U.S. Cl. 439/284

(57) ABSTRACT

An in-line hermaphroditic electrical cable assembly with a high current rating, is disclosed. The in-line hermaphroditic electrical cable assembly includes contacts for both signal and power conductors. A freely rotatable contact terminal retainer retains the signal and power contacts. A hyperboloid socket terminal is used as a power contact. Complementary coupling housings are coupled together by urging together and twisting hermaphroditic electrical and structural components.

### FIELD OF THE INVENTION

This invention relates to the field of electrical cable coupling assemblies, and in particular, to an in-line hermaphroditic electrical coupling mechanism for a cable contact arrangement that incorporates both a signal contact and a power contact.

### BACKGROUND OF THE INVENTION

It is well known to provide electrical cables with contacts that may easily fit together in order to electrically connect the cables. An example of an especially convenient cable contact is the pin and socket contact. The pin and socket contact permits connection of two cables by simply sliding a pin on one cable into a socket on the other. One type of widely used pin and socket contact, is the in-line insertion type.

Electrical apparatuses of various types are often required to include a convenient, simultaneous connection/disconnection for a plurality of in-series conductors. Very often both the power and signal contacts require separate cables for routing. Automotive vehicles for example, represent a typical environment wherein it is desired to provide for the quick assembly of a plurality of conductors in series. As is well known, today's automobiles employ a rather sophisticated electrical system containing many wiring harnesses involving hundreds of circuits transmitted throughout the engine compartment, the vehicle interior, and the trunk which require both signal and power contacts. To facilitate not only the initial assembly of the vehicle, but also to accommodate subsequent repair, testing and replacement, it is important that releasable connectors be utilized throughout the numerous involved wiring harnesses. With the influx of computer control systems, it becomes necessary to allow for the in-line insertion of electronic instruments for checking the digital circuits, not only in vehicles but in an assortment of various other apparatus.

Hermaphroditic cable assemblies allow either end of a respective conductor to mate with itself. The coupling process can become most cumbersome when multiple cables are involved with both signal and power requirements. Also, it is most desirable that an improved conductor termination be provided, not only to insure the highest possible amperage rating, but also to permit quick and positive insertion and retention of the terminations within a connector housing. A RADSOK® termination provides such a termination.

RADSOK® is the trademark for a patented high performance hyperboloid socket and pin-style electrical contact system for applications 30 amps and above. The hyperboloid connectors offer superior performance when compared with standard pin and socket connectors. In the RADSOK® terminal, multiple contacting elements are hyperbolically arrayed around the inner diameter of the socket. In addition, each of the contact elements is skewed with respect to the axial direction of the terminal. The result is multiple contact surfaces comprise a contact grid. The hyperbolic configuration results in a mechanical interference between an inserted pin and the contact elements. When a pin is inserted into the socket, the contacting elements of the grid mechanically wrap around the pin providing pressure necessary for superior electrical connection.

Because it is desirable to design pin and socket contacts to be as simple as possible, many of the conventional contact arrangements lack any sort of durable, but simple latching mechanism. Continuous use in which strain is placed on the cables in a direction that would cause the contacts to be pulled apart is prevalent in the industry. Current methods of providing a latching mechanism by trapping the contacts inside an elaborate connector have been lacking in structural integrity. One solution has been to combine the mating and un-mating mechanism with the latching mechanism combined.

Thus, a need exists in the industry to provide an in-line cable assembly which is hermaphroditic, allows a higher current rating such as that provided with a RADSOK® socket, provides an adequate latching mechanism, and allows the end user to have one cable instead of two to accommodate the power and signal needs, simultaneously.

### SUMMARY OF THE INVENTION

The present invention provides a system and method for electrically coupling a pin contact to a socket contact for in an in-line hermaphroditic electrical cable assembly that accommodates both signal and power requirements in one cable.

Briefly described, in architecture, a preferred embodiment of the system, among others, can be implemented as follows. A contact terminal retainer is provided and is press-fit within a first coupling housing. Two latch arms are provided, integrally molded to an exterior surface of the coupling sleeve. A latch ear is provided at one end of each latch arm to engage with two grooves on the coupling housing to form ramp surfaces. The contact terminal retainer includes pin and socket contacts for a signal conductor. A pin contact terminal is provided in the contact terminal contact to satisfy a power conductor requirement. A hyperboloid socket terminal is also included within the contact terminal retainer to complement the pin contact terminal. A second coupling housing with matching end connectors as described above is brought end-to-end with the first coupling housing. Upon mating the contacts and rotating the two coupling housings, the twisting movement mates the latch ears of the first coupling housing to the grooves of the second coupling housing, and the latch ears of the second coupling housing to the grooves of the first coupling housing. Because the contact terminal retainer is structured to freely rotate within the coupling housing, it may remain stationary during a coupling procedure to facilitate proper interconnection of the contacts while the coupling housings rotate freely.

In another embodiment of the present invention the hermaphroditic electrical cable assembly is structured in a welding receptacle pin and socket assembly. In this embodiment, a flange mount receptacle is integrally molded to the coupling housing.

Other systems, methods, features, and advantages of the present invention will become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout several views.

FIG. 1 is a drawing of a perspective view of a preferred embodiment of an in-line electrical cable assembly in accordance with the invention.

FIG. 2 is another perspective view of the drawing depicted in FIG. 1.

FIG. 3 is a front view of the drawing depicted in FIG. 1.

FIG. 4 is a drawing of a cross-sectional view of FIG. 3 along the lines as indicated.

FIG. 5 is a drawing of a cross-sectional view of FIG. 3 along the lines as indicated.

FIG. 6 is a drawing of a perspective view of the in-line electrical cable assembly in a receptacle in accordance with the invention.

FIG. 7 is another perspective view of the drawing depicted in FIG. 6.

FIG. 8 is a front view of the drawing depicted in FIG. 6.

FIG. 9 is a drawing of a cross-sectional view of FIG. 6 along the lines as indicated.

FIG. 10 is a drawing of a cross-sectional view of FIG. 6 along the lines as indicated.

### DETAILED DESCRIPTION OF THE PREFERRED EMBODIMENT

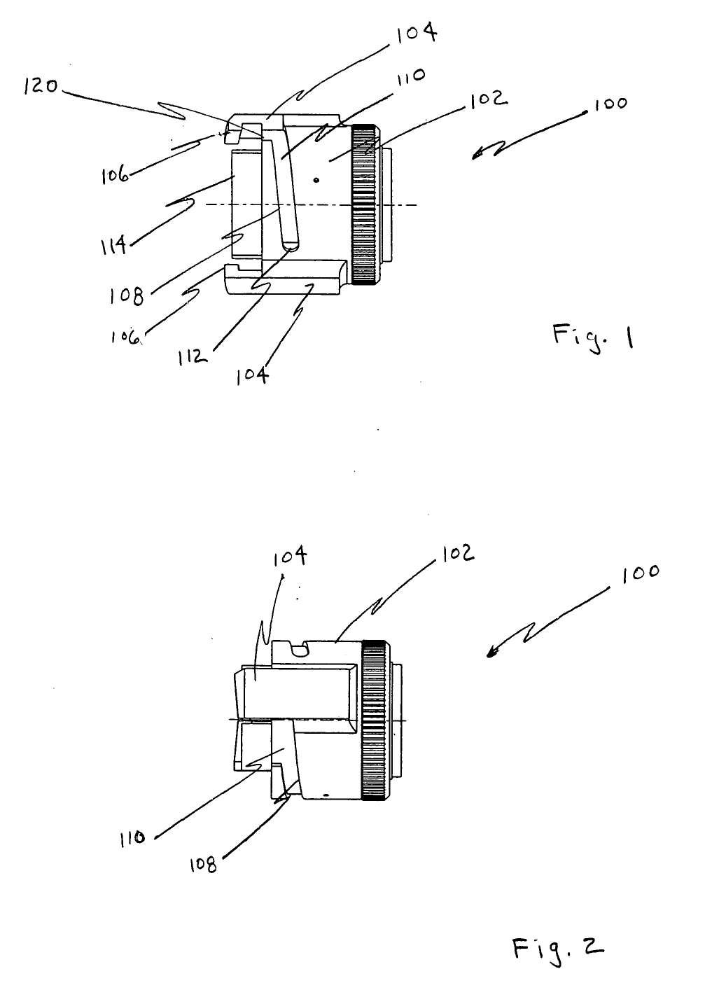

FIGS. 1-5 illustrate a preferred embodiment of a hermaphroditic in-line electrical cable assembly 100 in accordance with the invention.

In FIGS. 1 and 2, a coupling housing 102 includes two latch arms 104 that are integrally molded to an exterior surface of the coupling housing 102. The latch arms 104 are positioned radially opposite each other on the coupling housing 102. A latch ear 106 is disposed at one end of each latch arm 104. The latch ears 106 will be used to interlock two coupling housings 102 together. FIG. 1 illustrates the latch arms 104 with corresponding latch ears 106 positioned radially opposed to each other.

Two grooves 108 are disposed in the exterior surface at one end of the coupling housing 102. The grooves 108 form a ramp surface 110 (FIG. 2) to accept the latch ears 106 of a second coupling housing 102 when mating. A raised detent 112 is positioned on the ramp surface 110 to resist rotational movement of the latch ear 106 within the groove 108 when the coupling housings 102 are latched together.

A contact terminal retainer 114 is positioned and retained in the interior of the coupling housing 102. The contact terminal retainer 114 is adapted to rotate freely within the coupling housing 102.

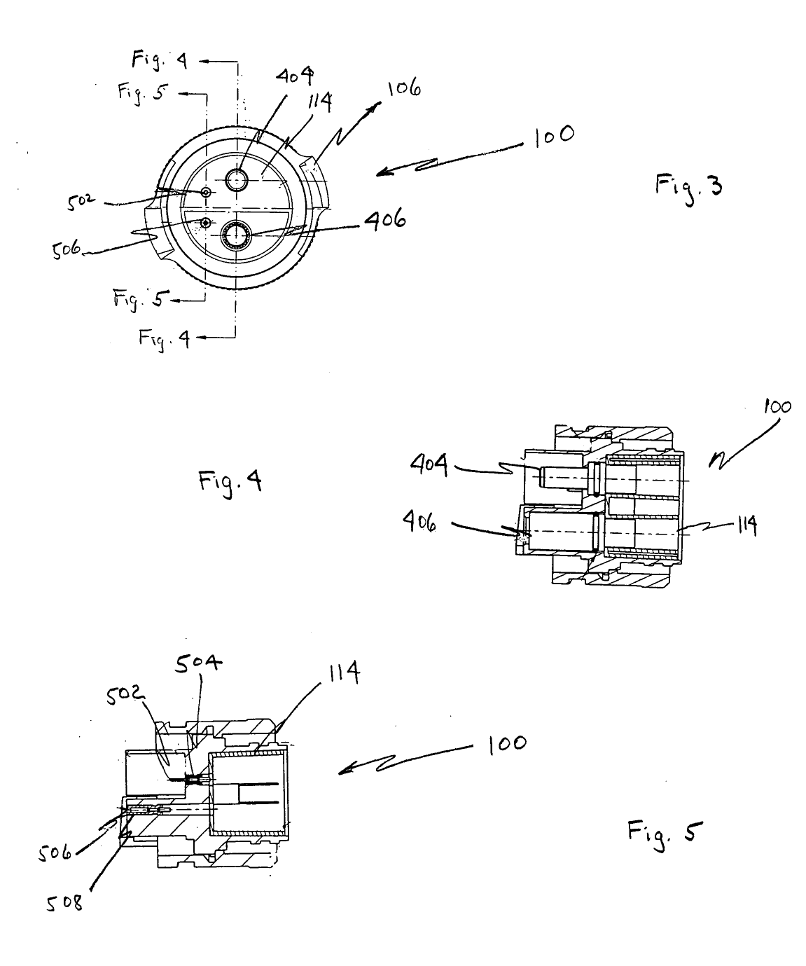

FIG. 3 depicts a front view of the electrical cable assembly 100. Both signal and power contacts are visible in the contact terminal retainer 114. FIGS. 4 and 5 represent cross-sectional views through the power and signal contacts, respectively.

In FIG. 4, a pin contact terminal 404 is positioned within the contact terminal retainer 114. A mating hyperboloid socket terminal 406 is also positioned within the contact terminal retainer 114 in the vicinity of the pin contact terminal 404. The pin contact and socket terminals 404,406 are used to address the power requirements of the particular situation.

In FIG. 5, a pin contact 502 is positioned within the contact terminal retainer 114. A pin insert 504 is disposed in the contact terminal retainer 114 and supports the pin contact 502 within the contact terminal retainer 114. A mating socket contact 506 is also positioned within the contact terminal retainer 114 in the vicinity of the pin contact 502. A socket insert 508 is disposed in the contact terminal retainer 114 and supports the socket contact 506 within the contact terminal retainer 114. The pin and socket contacts 502,506 address the signal requirements of the particular situation.

To couple two coupling housings 102 together, the two coupling housings 102 are urged towards each other to matching mating hermaphroditic power and signal parts. The latch ears 106 of the two coupling housings 102 enter grooves 108 through openings 120 and are aligned with the grooves 108. Once aligned, a clockwise rotational movement of the opposing coupling housings 102 interlocks the latch ears 106 within the grooves 108 along the ramp surfaces 110. The rotational movement of the two coupling housings 102 is impeded when the latch ears 106 encounter the raised detents 112. The raised detents 112 present an obstacle to any further rotational movement of the latch ears 106 within the grooves 108, and can be overcome with additional forceful urging of the latch ears 106 within the grooves 108. Because the contact terminal retainer 114 freely rotates within the coupling housing 102, the contact terminal retainer 114 remains stationary during the coupling procedure, thus facilitating proper interconnection of the contacts while the coupling housings 102 rotate freely. The raised detents 112 present a resistive obstacle to overcome when uncoupling the coupling housings 102. The raised detents 112 also hamper any unwanted loosening of the coupled coupling housings 102.

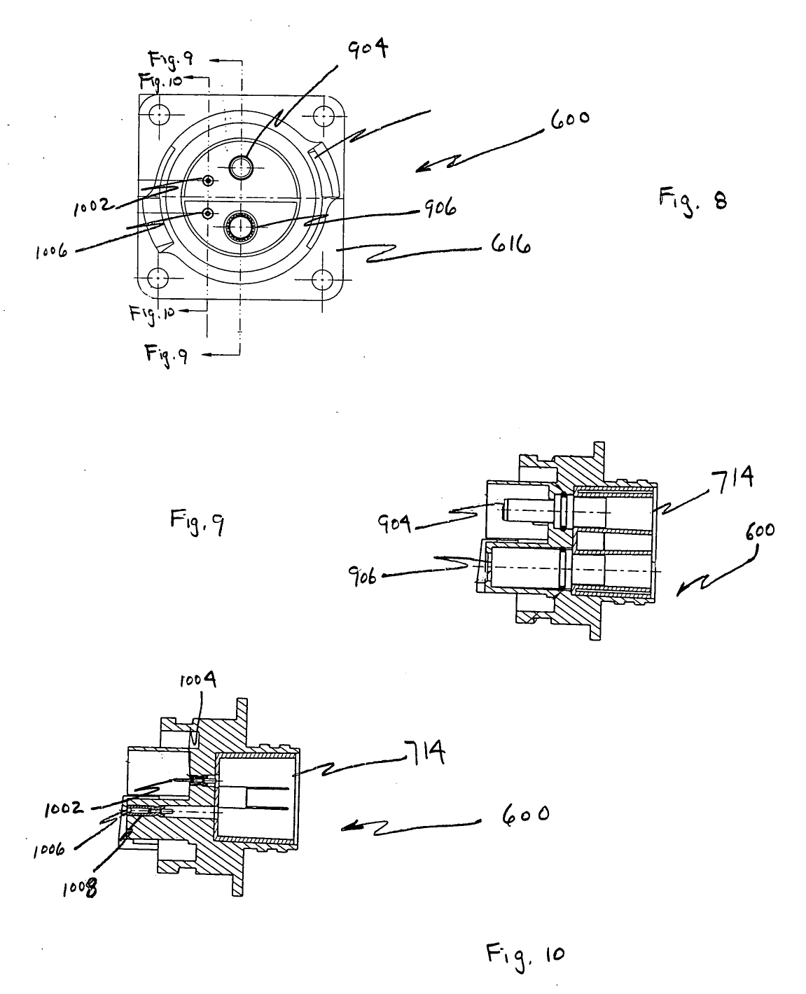

FIGS. 6-10 illustrate another embodiment of a hermaphroditic cable assembly 500 installed within a conventional welding receptacle.

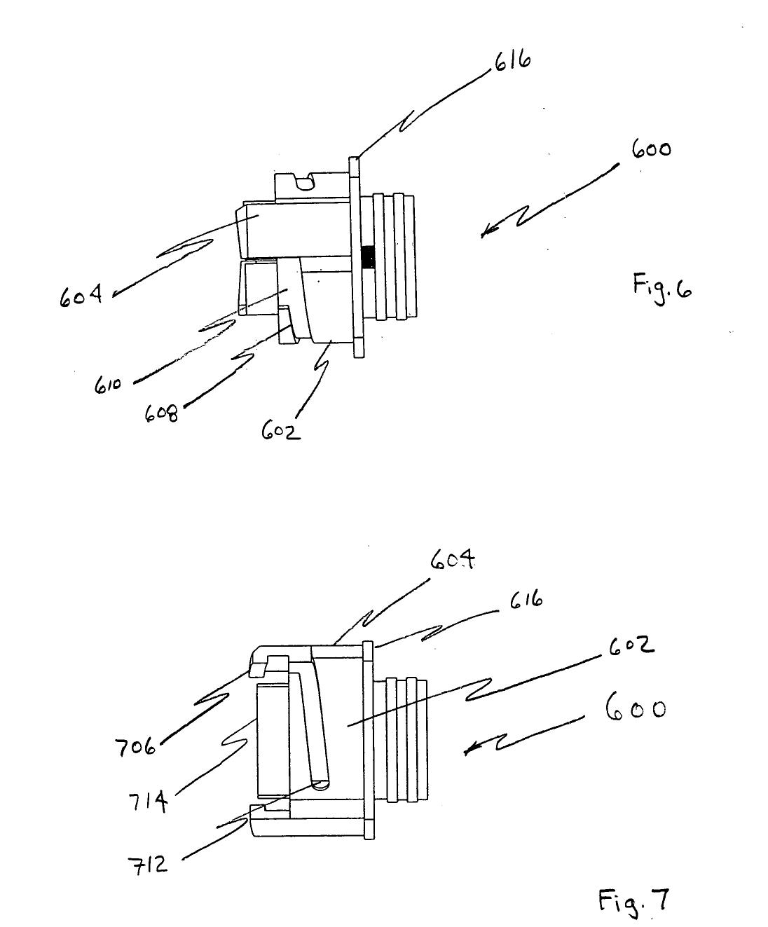

In FIGS. 6 and 7, the coupling housing 602 includes two latch arms 604 that are integrally molded to an exterior surface of the coupling housing 602. The latch arms 604, latch ears 706, grooves 608, ramp surface 610, raised detent 712, and contact terminal retainer 714 are structured and arranged in an orientation as described above for the embodiment shown in FIGS. 1-5. However, in this embodiment, a flange mount receptacle 616 is integrally molded to the back end of the coupling housing 602. The flange mount receptacle 616 does not rotate except in conjunction with the coupling housing 602 around the center axis of the contact terminal retainer 714 to facilitate a wall or panel mounting, while maintaining a stationary target via the contact terminal retainer 714 for coupling of the contacts. In coupling, a second coupling housing 602 is urged forward to mate the respective contacts contained in the contact terminal retainer 714, and then rotate to latch its latch arms 602 into the grooves 608 of the coupling housing 602 that is integrally molded to the flange mount receptacle 616.

In FIGS. 9 and 10, pin contact terminal 904, the hyperboloid socket terminal 906, the pin contact 1002, and the socket contact 1006 are depicted. These terminals and contacts are the same as described with respect to the embodiment of FIGS. 1-5. The remaining structural elements duplicate those included in FIGS. 1-5.

With regard to coupling, the same manner of coupling the coupling housings 102 as described above for FIGS. 1-5 is used.

It should be emphasized that the above-described embodiments of the present invention, particularly, any preferred embodiments, are merely possible examples of implementations, merely set forth for a clear understanding of the principles of the invention. Many variations and modifications may be made to the above-described embodiments of the invention without the departing substantially from the spirit and principles of the invention. All such modifications and variations are intended to be included herein within the scope of this disclosure and the present invention, and protected by the following claims.

1. An in-line hermaphroditic electrical cable assembly, comprising:
a coupling housing;
at least two latch arms integrally molded to an exterior surface of said coupling housing and positioned radially opposite each other at one end of the coupling housing;
a latch ear disposed at one end of each latch arm;
at least one groove on the exterior surface at the one end of said coupling housing and forming a ramp surface to accept the latch ear;
a contact terminal retainer positioned and retained interior to said coupling housing and adapted to rotate freely within said coupling housing;
at least one hyperboloid socket terminal positioned within said contact terminal retainer;
at least one pin contact terminal positioned within said contact terminal retainer;
at least one pin contact positioned within said contact terminal retainer; and
at least one socket contact positioned within said contact terminal retainer.

2. The in-line hermaphroditic electrical cable assembly of claim 1, wherein the ramp surface includes a raised detent to resist a rotational movement of the latch ear within the groove.

3. The in-line hermaphroditic electrical cable assembly of claim 1, wherein the contact terminal retainer includes at least one pin insert and at least one socket insert to house the at least one pin contact and the at least one socket contact, respectively.

4. An in-line hermaphroditic electrical cable assembly, comprising:
a coupling housing;
two latch arms integrally molded on an exterior surface of said coupling housing and positioned radially opposite each other at one end of the coupling housing;
a latch ear disposed at one end of each latch arm;
two grooves engraved on the exterior surface at the one end of said coupling housing and forming a pair of ramp surfaces to accept the latch ears;
a raised detent within each groove to resist rotational movement of the latch ears within the grooves;
a contact terminal retainer positioned and retained interior to said coupling housing and adapted to rotate freely within said coupling housing;
a hyperboloid socket terminal positioned within said contact terminal retainer;
a pin contact terminal positioned within said contact terminal retainer;
a pin contact positioned within said contact terminal retainer; and
a socket contact positioned within said contact terminal retainer.

5. The in-line hermaphroditic electrical cable assembly of claim 4, wherein a pin insert secures the pin contact within the contact terminal retainer.

6. The in-line hermaphroditic electrical cable assembly of claim 4, wherein a socket insert secures the socket contact within the contact terminal retainer.

7. An in-line hermaphroditic electrical cable assembly, comprising:
a coupling housing;
a flange mount receptacle integrally molded to the one end of said coupling housing;
at least two latch arms integrally molded to the exterior surface of said coupling housing and positioned radially opposite each other at the other end of the coupling housing;
a latch ear disposed at one end of each latch arm;
at least one groove engraved on the exterior surface at the other end of said coupling housing and forming a ramp surface to accept the latch ear;
a contact terminal retainer positioned and retained interior to said coupling housing and adapted to rotate freely within said coupling housing;
at least one hyperboloid socket terminal positioned within said contact terminal retainer;
at least one pin contact terminal positioned within said contact terminal retainer;
at least one pin contact positioned within said contact terminal retainer; and
at least one socket contact positioned within said contact terminal retainer.

8. The in-line hermaphroditic electrical cable assembly of claim 7, wherein the ramp surface includes a raised detent to resist a rotational movement of the latch ear within the groove.

9. The in-line hermaphroditic electrical cable assembly of claim 7, wherein the contact terminal retainer includes at least one pin insert and at least one socket insert to house the at least one pin contact and the at least one socket contact, respectively.

10. An in-line hermaphroditic electrical cable assembly, comprising:
a coupling housing;
a flange mount receptacle integrally molded to the one end of said coupling housing and retained by said two retainer snaps;
two latch arms integrally molded on the exterior surface of said coupling housing and positioned radially opposite each other at the other end of said coupling housing;
a latch ear disposed at one end of each latch arm;
two grooves on the exterior surface at the other end of said coupling housing and forming a pair of ramp surfaces to accept the latch ears;
a raised detent within each groove to resist rotational movement of the latch ears within the grooves;
a contact terminal retainer positioned and retained interior to said coupling housing and adapted to rotate freely within said coupling housing;
a hyperboloid socket terminal positioned within said contact terminal retainer;
a pin contact terminal positioned within said contact terminal retainer;
a pin contact positioned within said contact terminal retainer; and
a socket contact positioned within said contact terminal retainer.

11. The in-line hermaphroditic electrical cable assembly of claim 10, wherein a pin insert secures the pin contact within the contact terminal retainer.

12. The in-line hermaphroditic electrical cable assembly of claim 10, wherein a socket insert secures the socket contact within the contact terminal retainer.

13. A method for coupling an in-line hermaphroditic electrical cable assembly, said method comprising:
providing a coupling housing with two latch arms integrally molded to an exterior surface of said first coupling sleeve and radially positioned opposite each other at one end of the coupling sleeve;
mounting said coupling housing within a flange mount receptacle located at the other end of the coupling housing;
disposing two grooves, each at the one end of said coupling housing and forming ramp surfaces to accept said latch ears;
retaining a contact terminal retainer interior to said coupling housing and allowing said contact terminal retainer to rotate freely within said coupling housing;
providing a hyperboloid socket terminal positioned within said contact terminal retainer;
providing a pin contact terminal positioned within said contact terminal retainer;
providing a pin contact positioned within said contact terminal retainer;
providing a socket contact positioned within said contact terminal retainer; and
coupling the coupling housing to another coupling housing by urging the latch ears into an opening in the grooves and rotating, respectively.

14. The method according to claim 13, further comprising:
providing at least one raised detent on each ramp surface to resist rotational movement of the latch ear within the groove.

15. The method according to claim 14, wherein a RADSOK® socket terminal is provided.
